(19) United States
(12) Patent Application Publication
(10) Pub. No.: US 2007/0168880 A1
(43) Pub. Date: Jul. 19, 2007

(54) Method and system for question tracking and information presentation

(76) Inventor: Gary A. Hoberman, Merrick, NY (US)

Correspondence Address: MILBANK, TWEED, HADLEY & MCCLOY, 1 CHASE MANHATTAN PLAZA, NEW YORK, NY, 10005-1413, US

(21) Appl. No.: 11/335,335

(22) Filed: Jan. 19, 2006

(51) Int. Cl. G06F 3/048; G06F 17/00

(52) U.S. Cl. 715/810; 715/500; 715/513; 715/764; 715/765

(57) ABSTRACT

To develop a computerized questionnaire, a plurality of options are provided in a template. The options include a section option, an open text option, a single choice option, a multiple choice option, a yes/no option, a message only option, a required attribute option, an attachment option, a next question option, a column width attribute, a validation URL option, a search option, and a browser option. One option in the template is selected for each of a plurality of questions, and the plurality of questions and associated options are stored in a standard document (e.g., XML) for use in the computerized questionnaire.

The invention relates to the field of automated generation of questionnaires, and more particularly to the use of standardized templates for such generation.

### BACKGROUND

On-line or computerized questionnaires are known. Systems and methods for more efficient creation of these on-line or computerized questionnaires are needed.

The preceding description is not to be construed as an admission that any of the description is prior art relative to the present invention.

### SUMMARY OF THE INVENTION

In one aspect, the system and method of the invention are used to develop a computerized questionnaire. The system and method comprise providing a plurality of options in a single template. The system and method also comprise selecting one option in the template for each of a plurality of questions, and storing the plurality of questions and associated options in a standard document for use in a computerized questionnaire.

In another aspect of the system and method, the template further comprises a section option. In another aspect of the system and method, the template further comprises an open text option. In another aspect of the system and method, the template further comprises a single choice option. In another aspect of the system and method, the template further comprises a multiple choice option. In another aspect of the system and method, the template further comprises a yes/no option. In another aspect of the system and method, the template further comprises a message only option. In another aspect of the system and method, the template further comprises a required attribute option. In another aspect of the system and method, the template further comprises an attachment attribute option. In another aspect of the system and method, the template further comprises a column width attribute option. In another aspect of the system and method, the template further comprises a next question attribute option. In another aspect of the system and method, the template further comprises a validation URL option. In another aspect of the system and method, the template further comprises a search option. In another aspect of the system and method, the section option is a logical separator. In another aspect of the system and method, the section option groups questions. In another aspect of the system and method, the open text option prompts a user to type or paste data. In another aspect of the system and method, the open text option includes a data type option. In another aspect of the system and method, the open text option includes a data length option. In another aspect of the system and method, the open text option includes a validation pattern option. In another aspect of the system and method, the single choice option includes button options. In another aspect of the system and method, the single choice option includes a list box option. In another aspect of the system and method, the multiple choice option includes button options. In another aspect of the system and method, the multiple choice option includes a list box option. In another aspect of the system and method, the standard document is an XML document.

The foregoing specific aspects are illustrative of those which can be achieved and are not intended to be exhaustive or limiting of the possible advantages that can be realized. Thus, the objects and advantages will be apparent from the description herein or can be learned from practicing the invention, both as embodied herein or as modified in view of any variations which may be apparent to those skilled in the art. Accordingly the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates an example system according to one embodiment; and

FIGS. 2-39 illustrate example templates according to various embodiments.

It is understood that the drawings are for illustration only and are not limiting.

### DETAILED DESCRIPTION OF THE DRAWINGS

Using the embodiments described below, a questionnaire builder can select from standardized options on a questionnaire template to construct a linked questionnaire. In the process, the template provides the questionnaire builder with the standardized options and from the builder's selections, the system creates the questionnaire as an XML document.

An Example System

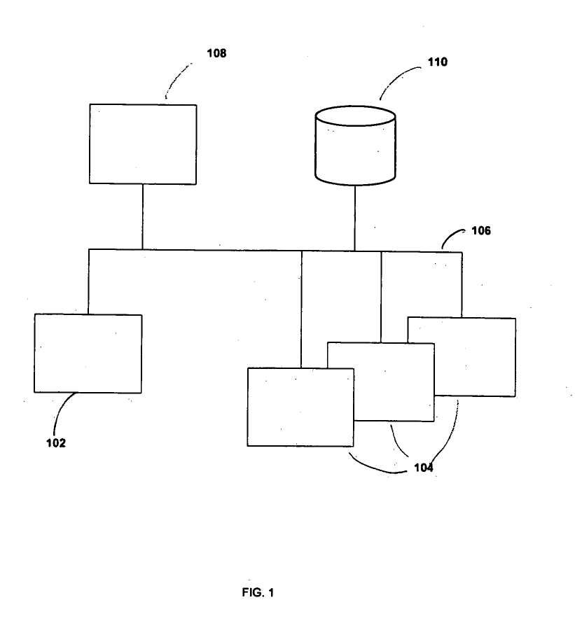

Referring to FIG. 1, an example system 100 according to an embodiment includes a questionnaire builder 102, and a plurality of questionnaire respondents 104. Builder 102 and respondents 104 are connected by a network 106, which is also connected to various servers 108 and databases 110. Although not illustrated some or all of builder 102, respondents 104, servers 108 and databases 110 include general purpose or special purpose computers with central processors (CPUs), memory (RAM, ROM, etc.), fixed and removable code storage devices or media (hard drives, floppy drives, CDs, DVDs, memory sticks, etc.) for storing computer-readable and executable code, data and information, input/output devices (keyboards, displays, pointing devices, printers, etc.), network and communication interfaces (Ethernet cards, NICs, WiFi cards, modems, etc.). Network 106 is any of various types of network (LAN, WAN, Extranet, Intranet, the Internet, PSTN, etc.). Software code that is stored on the fixed and removable code storage devices can be transmitted as an information signal, such as over network 106.

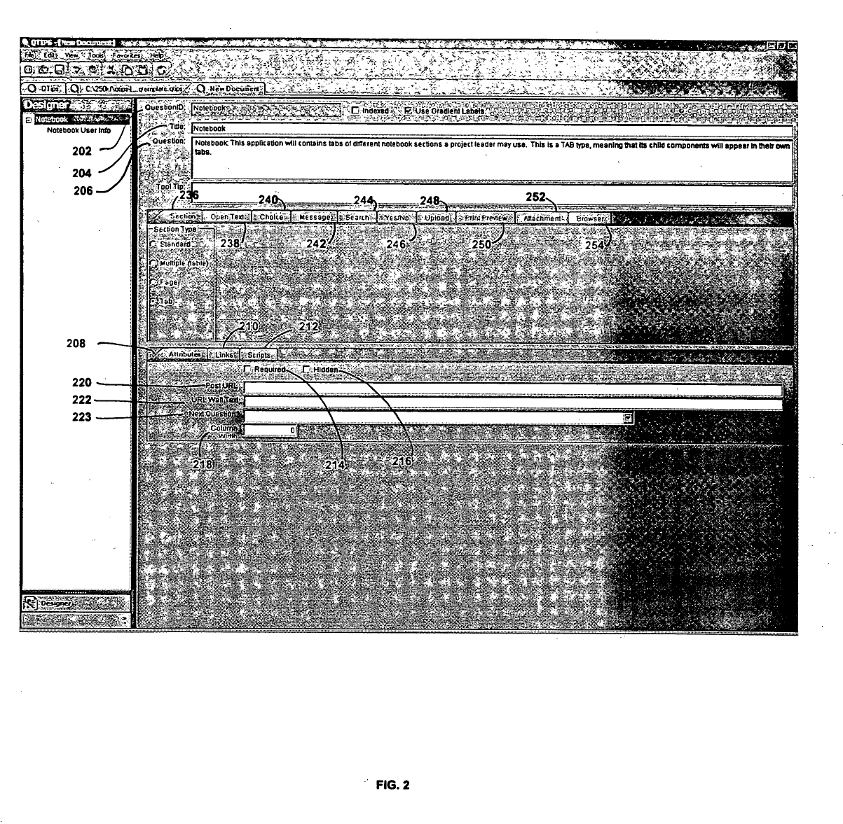

In various embodiments, a template is used by questionnaire builder 102 to develop computerized questionnaires that can be completed by questionnaire respondents 104. The template includes a number of options for the questionnaire as illustrated below with reference to FIGS. 2-39.

As illustrated in FIG. 2, the template has fields, which include a QuestionID data field 202, a Title data field 204, and a Question data field 206. The QuestionID field is used to uniquely identify a particular question, while the Title data field is displayed on the completed questionnaire when that particular question is presented to respondent 104. The Question data field contains the question or instructions for respondent 104.

Other fields or tables on the template include attributes 208, links 210 and scripts 212. Attributes for a question can be required 214, or hidden 216. Attributes include column width 218; Post URL 220; URL Wait Text 222; and Next Question 223. The column width specifies how wide the column is on respondent 104's scrollable view. Post URL is used to validate a response by respondent 104, and URL wait text is displayed to respondent 104 during validation.

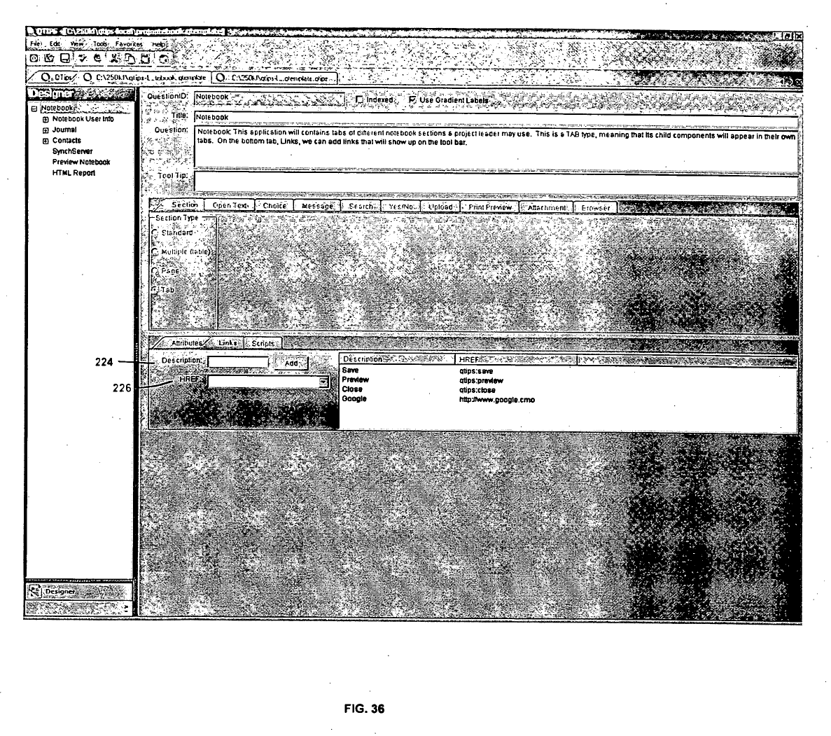

As illustrated in FIG. 36, links 210 include: descriptions 224 and HREFs 226, and can be used to create toolbars for the respondent 104.

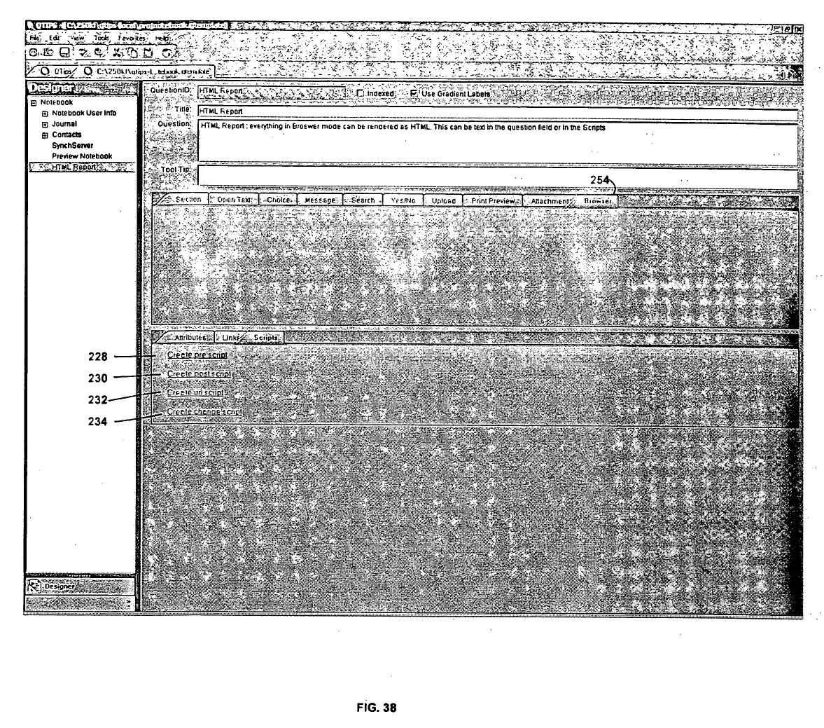

As illustrated in FIG. 38, scripts 212 include: create pre script 228; create post script 230; create url script 232; and create change script 234.

Builder 102 can select option templates depending on the type of question. The option templates include: Section 236; Open Text 238; Choice 240; Message 242; Search 244; Yes/No 246; Upload 248; Print Preview 250; Attachment 252; and Browser 254.

Use of the different option templates is illustrated by building a sample application called the Notebook. The Notebook will contain information on a user, a journal to record information from meetings, and an address book. The Notebook will also have the ability to synchronize with a server, perform print preview and produce HTML reports.

In FIG. 2, builder 102 has created a QuestionID 202 called Notebook, which is the application name. Builder 102 has also selected a Section Type 236 of Tab, meaning that any components under it (child elements) will be created as a new tab in the Notebook. Notebook is entered as the Title 204, and will be displayed to respondent 104 in the finished application. Builder 102 has also entered text as Question 206. The text entered in Question is also displayed to respondent 104 in the finished application.

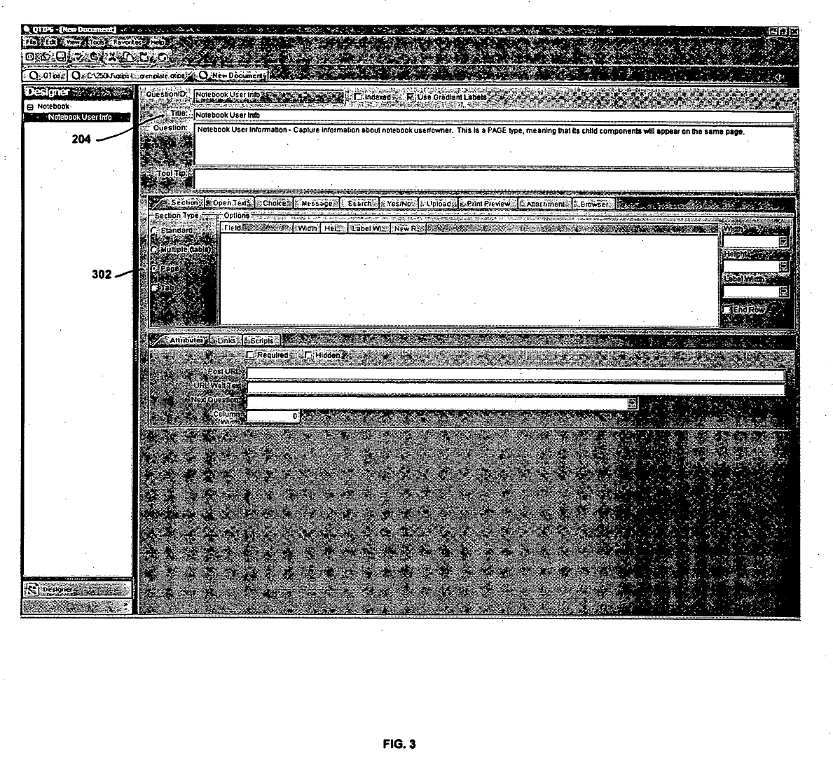

Referring to FIG. 3, builder 102 next creates a Section of type Page 302. A Page section type will keep all of the child elements in the same page or screen. The Title 204 is Notebook User Info.

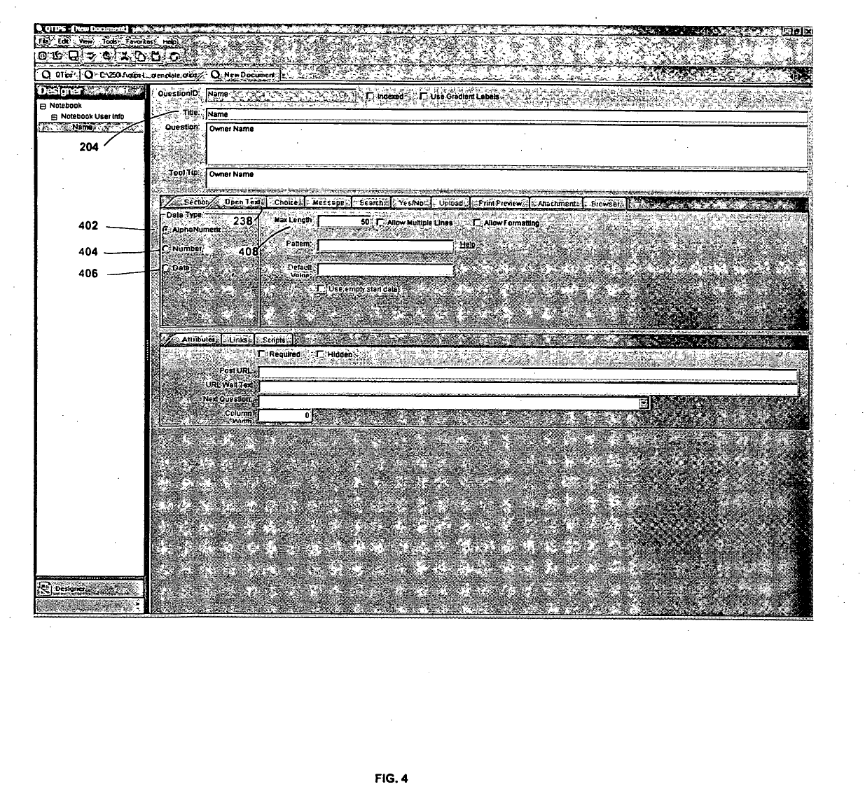

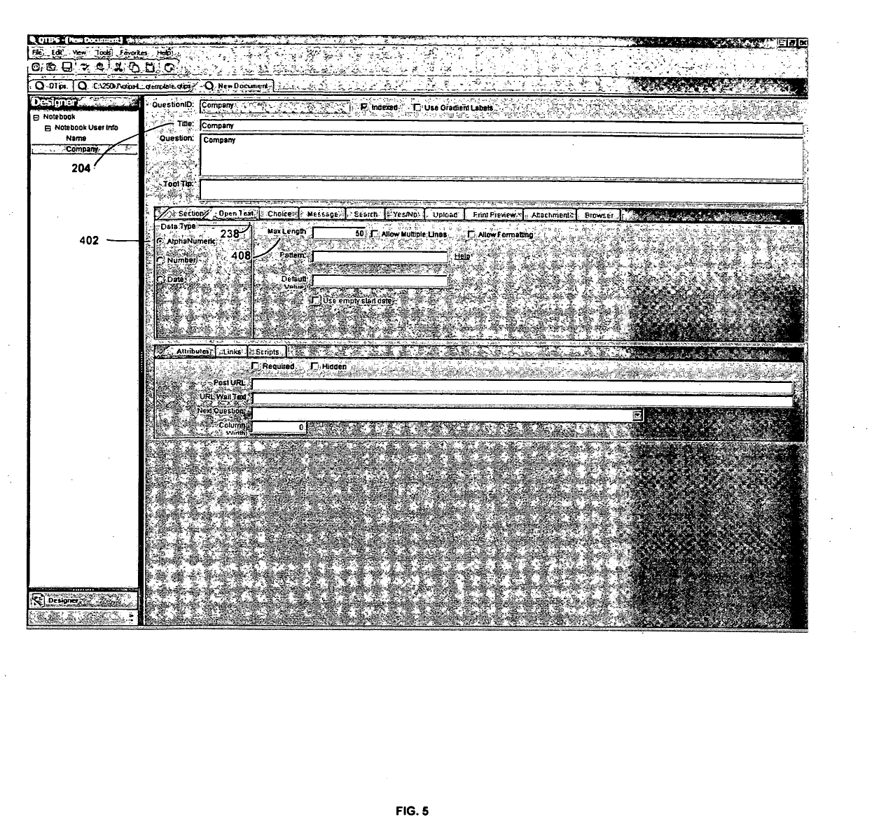

Referring to FIG. 4, builder 102 next selects an option template of Open Text 238. For an Open Text option template, Builder 102 can select from Data Type of Alphanumeric 402, Number 404 or Date 406. This field has a Title 204 of Name for entry of the Notebook owner's name, and in this example, the user has selected a Data Type of Alphanumeric 402, with a maximum length 408 of 50 characters. In a similar manner, in FIG. 5, builder 102 also wants to show the company, so selects another option Template of Open Text 238, with Alphanumeric Data Type 402 and 50 character maximum length 408. This field has the Title 204 of Company.

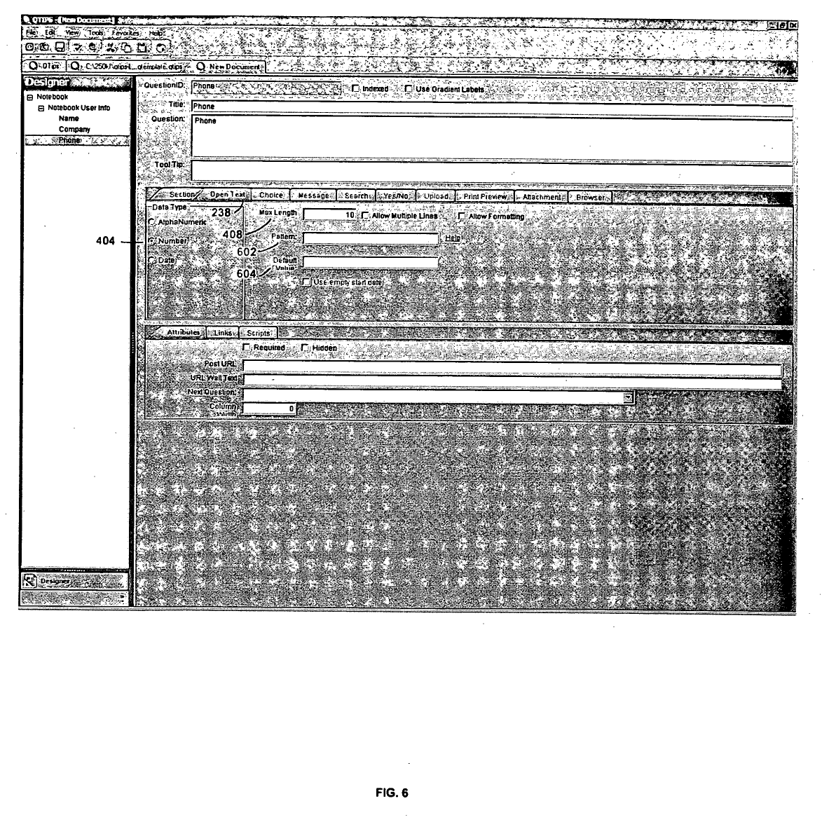

In FIG. 6, builder 102 again selects an option template of Open Text 238 to enter a phone number. This has a Data Type of Number 404, with a maximum length 408 of 10 digits. Builder 102 can also provide a pattern 602 or default value 604.

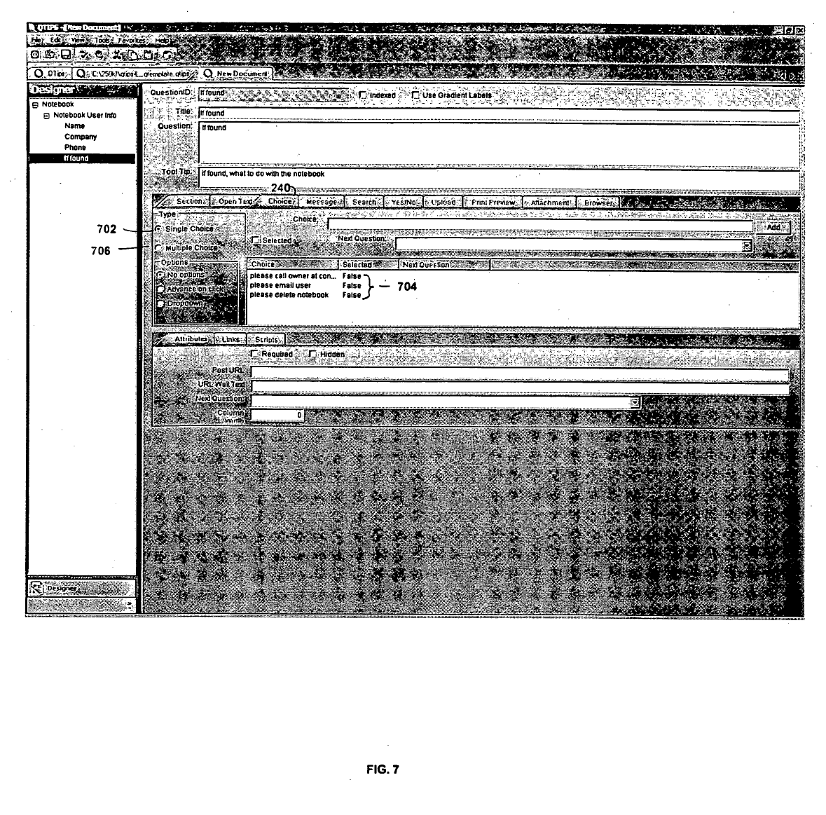

In FIG. 7, Builder 102 selects an option template of Choice 240, with type Single Choice 702. In the example, three single choices are provided 704 where only one choice can be made, and all are defaulted to false or unselected. Alternatively a multiple choice 706 could be selected where multiple items can be checked.

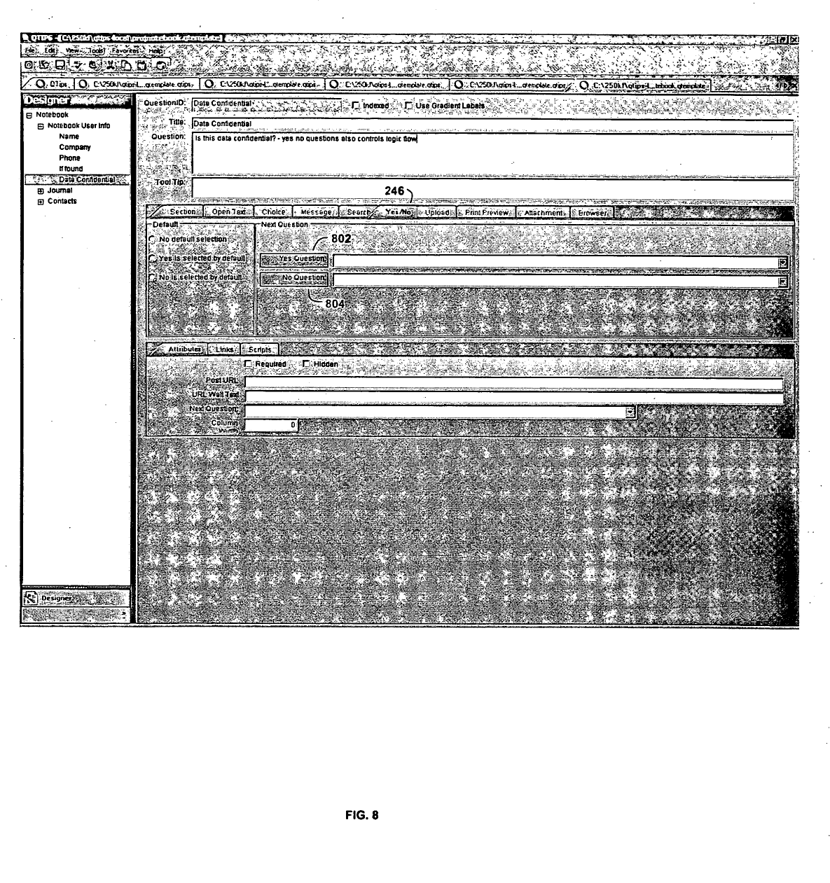

For the last entry under Notebook User Info, Builder 102 selects an option template of Yes/No 246 for Data Confidential in FIG. 8. Here, there are only two choices, and it is possible to provide logic that selects the next question depending on whether respondent 104 selects Yes 802 or No 804.

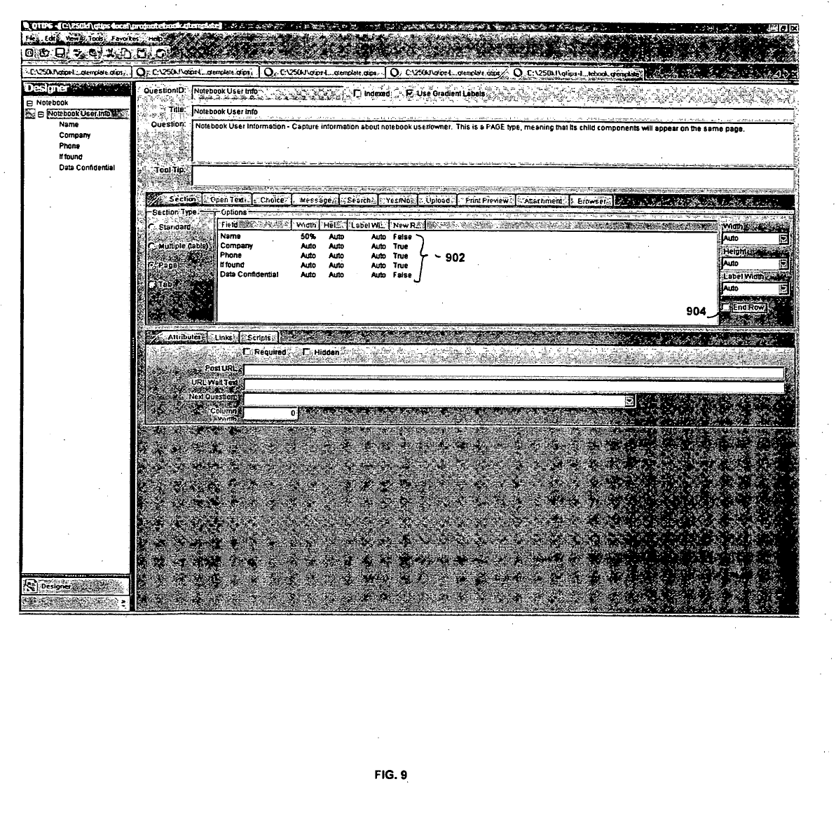

Going back to QuestionID Notebook User Info in FIG. 9, there are now five elements 902, and Builder 102 can adjust and edit placement and spacing of the elements on respondent 104's display by choosing the height and width of each element. The End Row check box 904 indicates that there will be no other elements after that element on the row, and the next element must start on a new row.

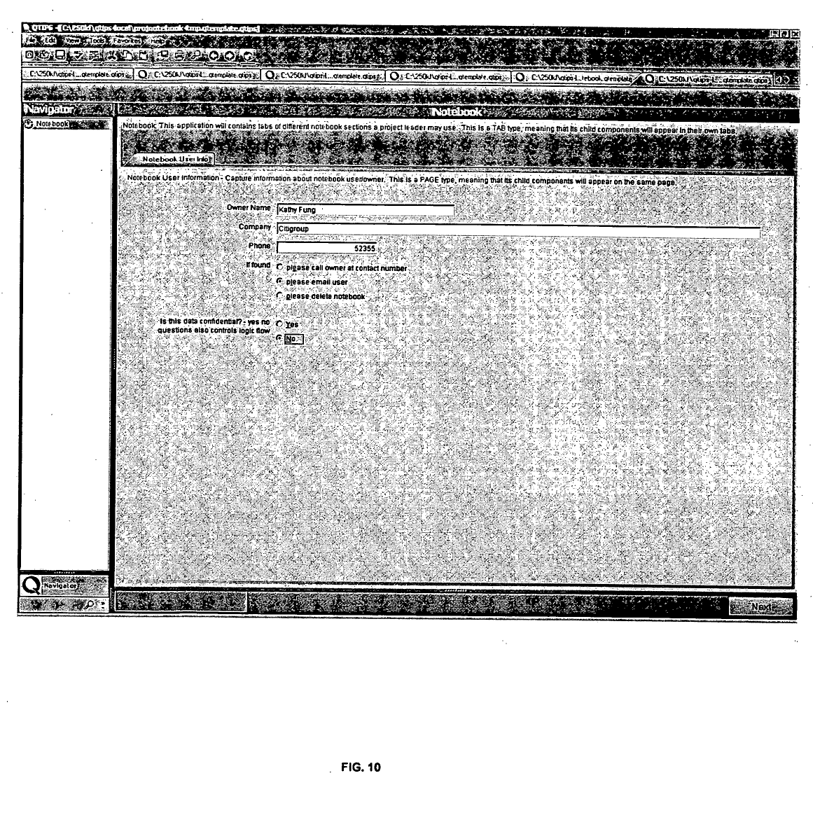

FIG. 10, provides a display of the Notebook User Info in the application as respondent 104 might see it.

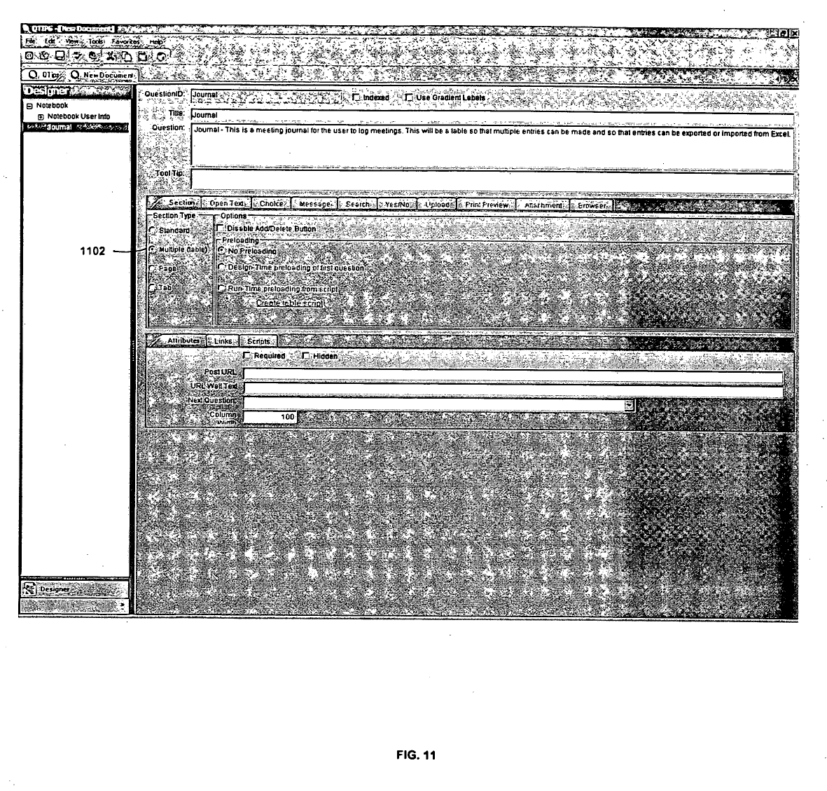

After Notebook User Info, builder 102 starts to create a Journal section for meetings in FIG. 11. This is a Section Type Multiple (table) 1102 that can be exported to or imported from Excel.

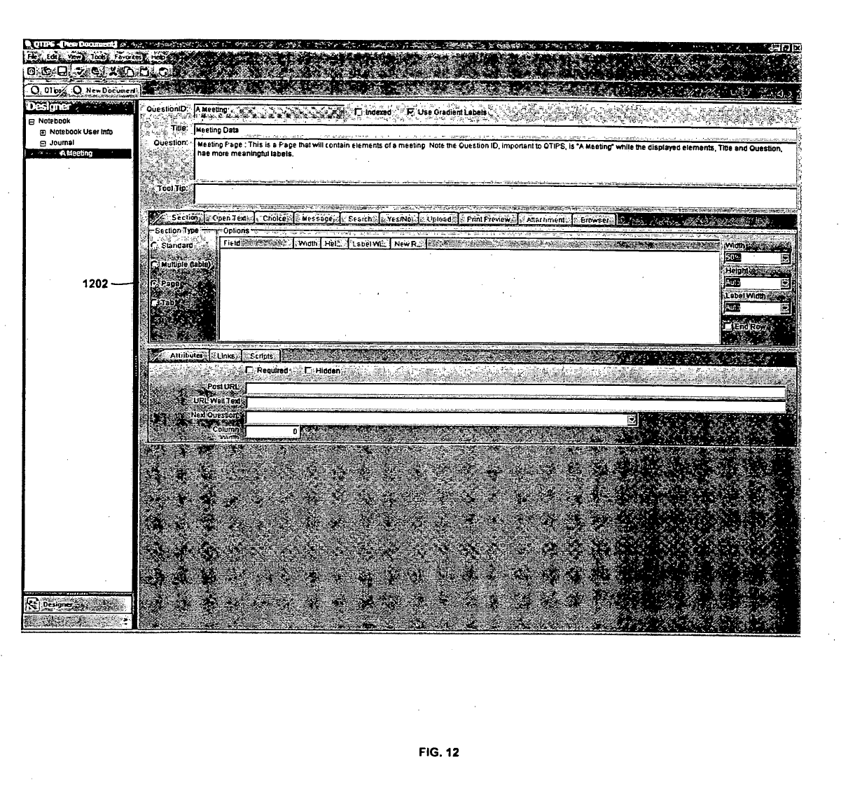

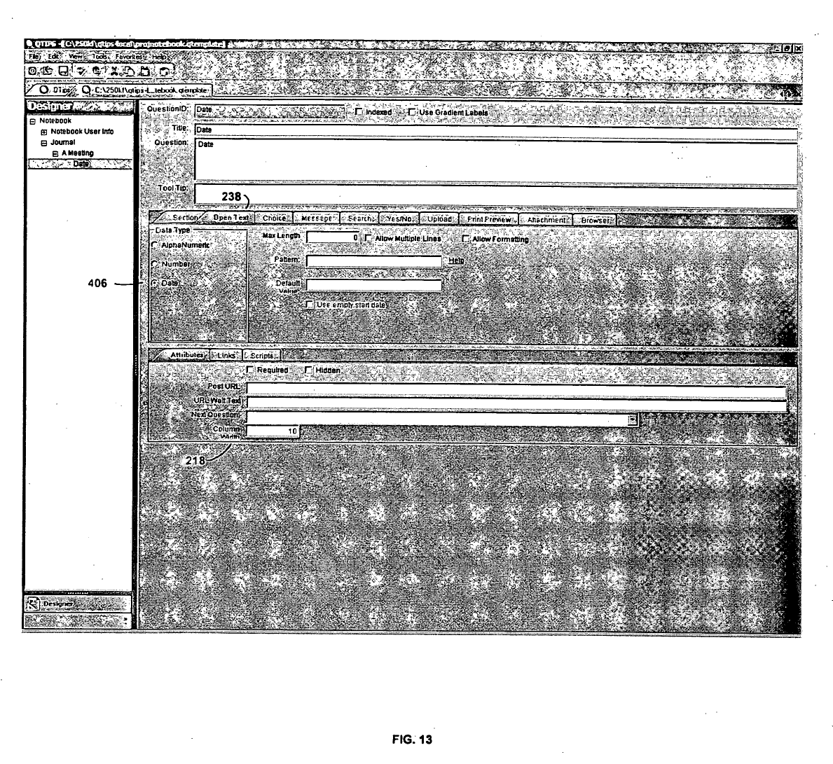

In FIG. 12, a section type of Page for meeting data is created. In FIG. 13, builder 102 selects an option template of Open Text 238 for the meeting Date, and selects a Data Type of Date 406. To display as a column heading, the column width 218 is entered, with a width of 10 characters.

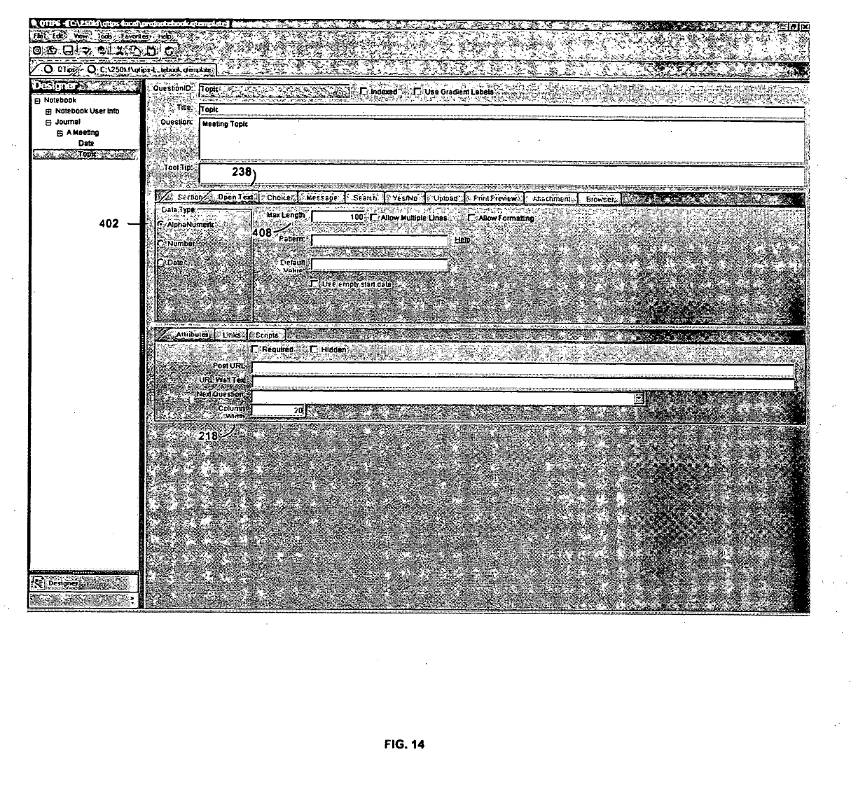

The meeting Topic field is also entered as an option template of Open Text 238 in FIG. 14. This has Data Type of Alphanumeric 402, with a maximum length 408 of 100 characters. The column width 218 is set to 20.

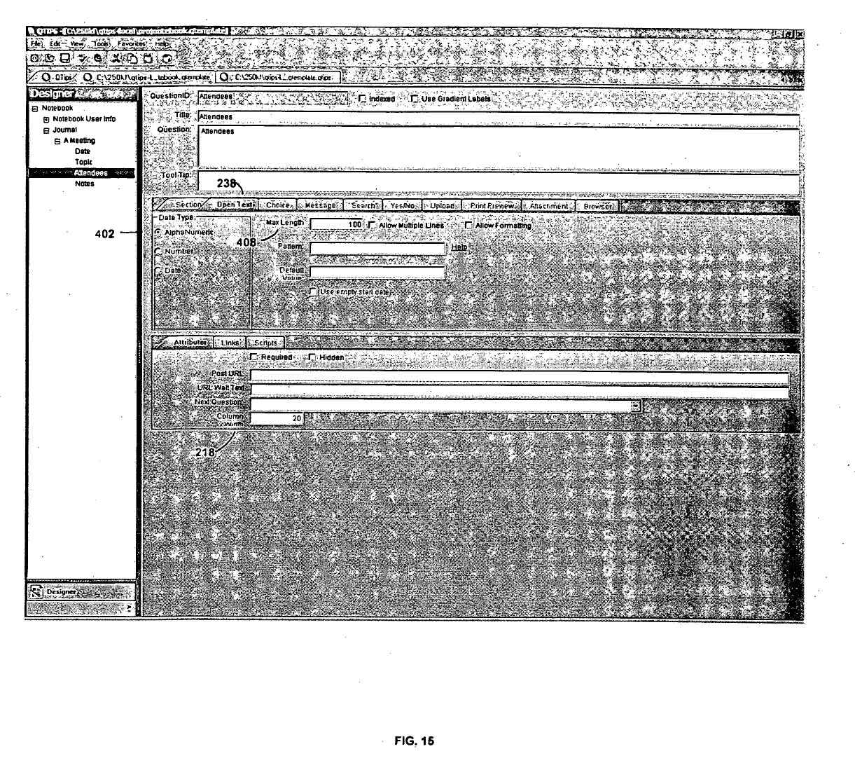

The meeting Attendees field is also entered as an option template of Open Text 238 in FIG. 15. This has Data Type of Alphanumeric 402, with a maximum length 408 of 100 characters. The column width 218 is set to 20.

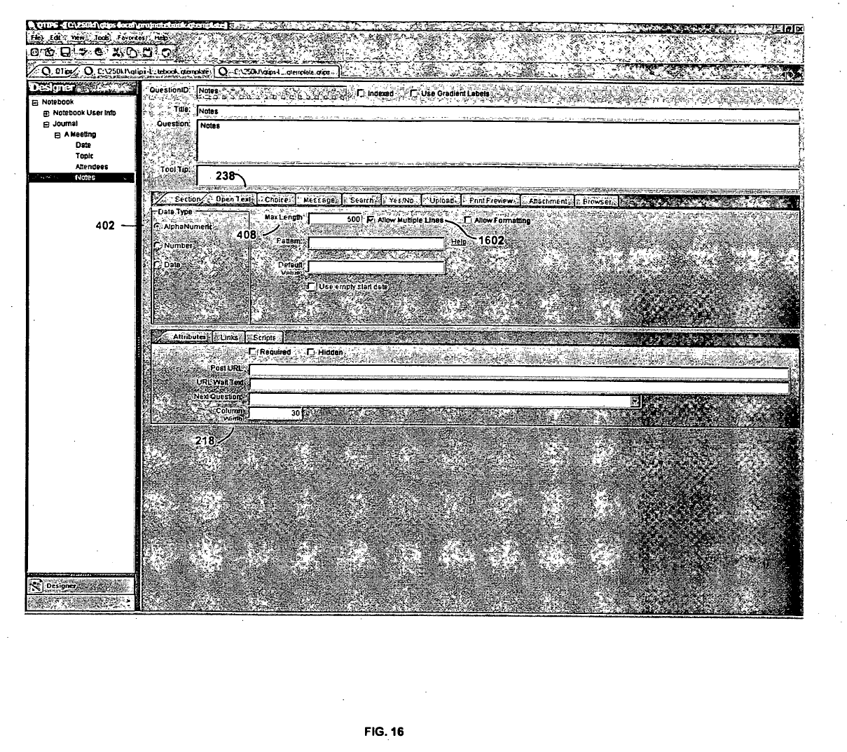

Builder 102 enters the Notes field as an option template of Open Text 238 with a Data Type of Alphanumeric 402 and a maximum length 408 of 500 characters in FIG. 16. Multiple lines 1602 are allowed for this field and the column width 218 is set to 30 characters.

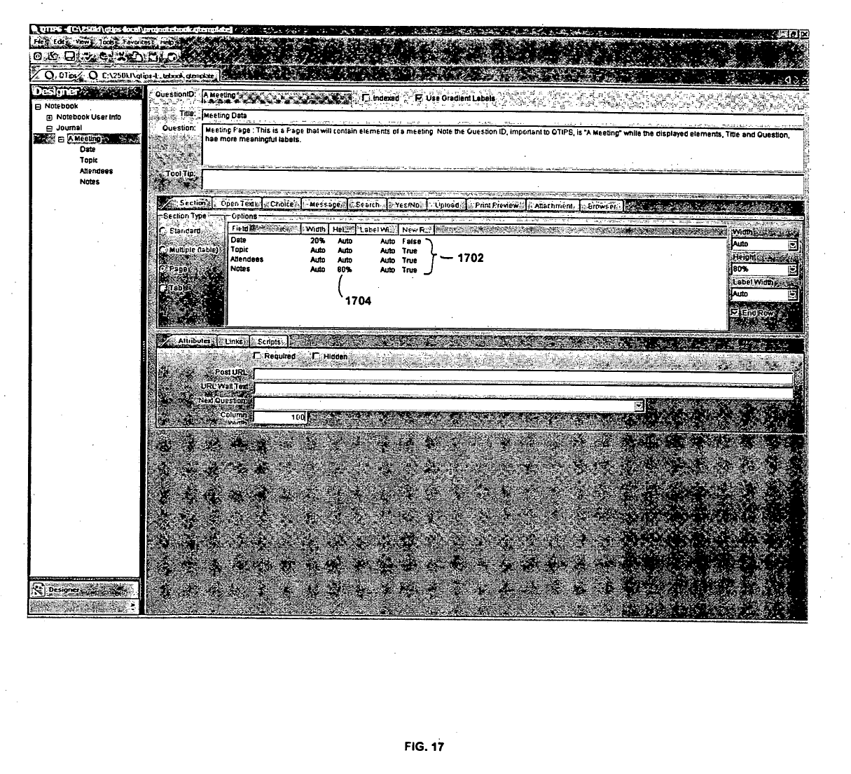

In FIG. 17, going back to the Meeting Data, each of the four fields 1702 are displayed and builder 102 can adjust the width and height of each element. In the example, the Notes field height 1704 is set to 80% to provide a large space for notes.

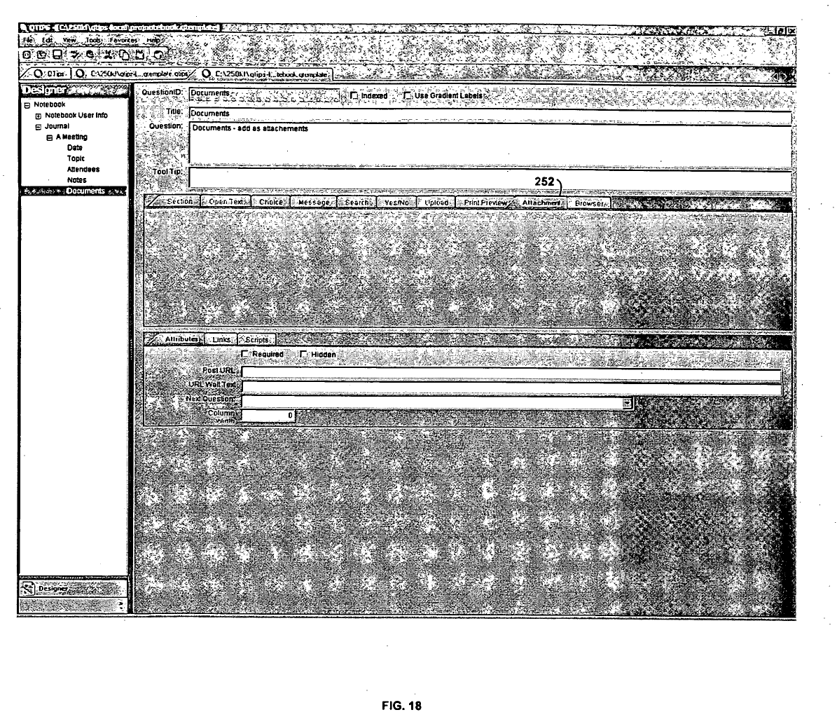

It is also helpful to allow attachments from meetings, and in FIG. 18, builder 102 selects an option template of Attachment 252. This will create an attachment area in the application where respondent 104 can drag and drop files or browse directories for the attachments.

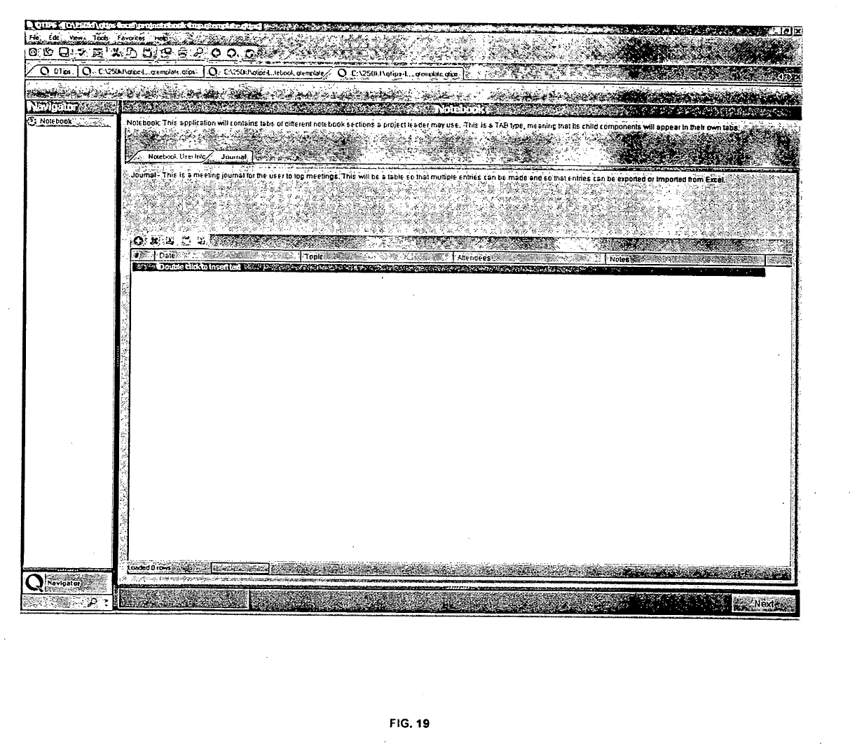

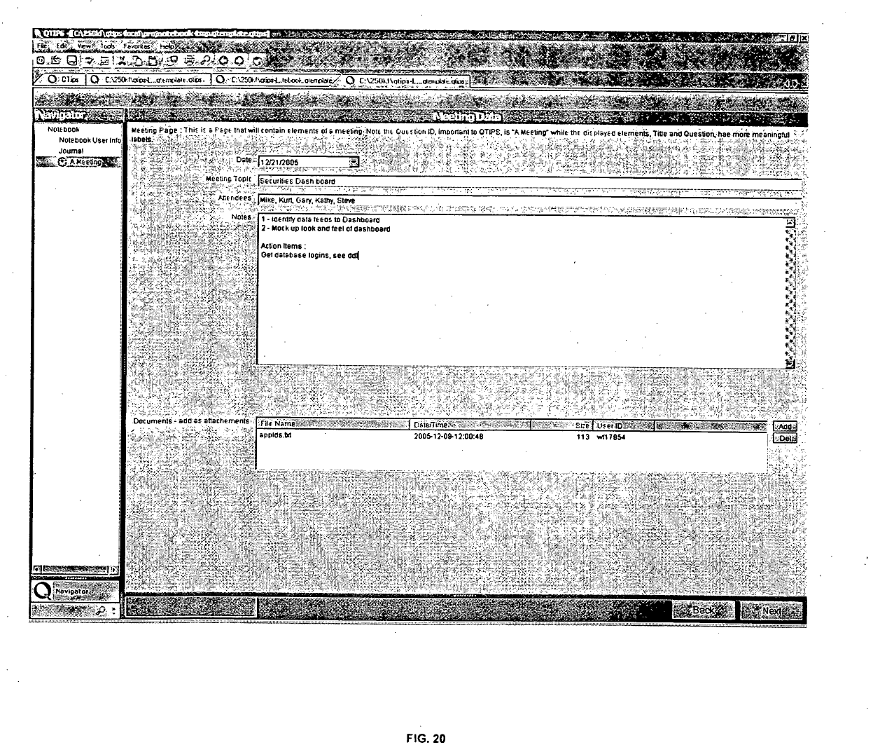

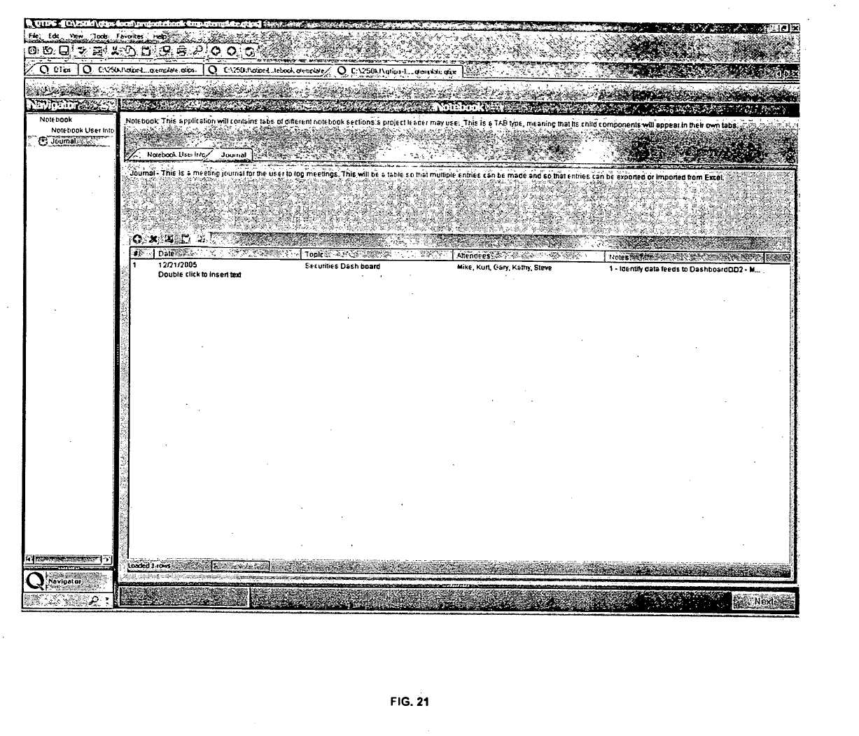

FIG. 19, provides a display of the Journal in the application as respondent 104 might see it, and FIG. 20 provides a display of a data entry screen for a meeting, while FIG. 21 provides a display of the Journal in the application after entry of some data.

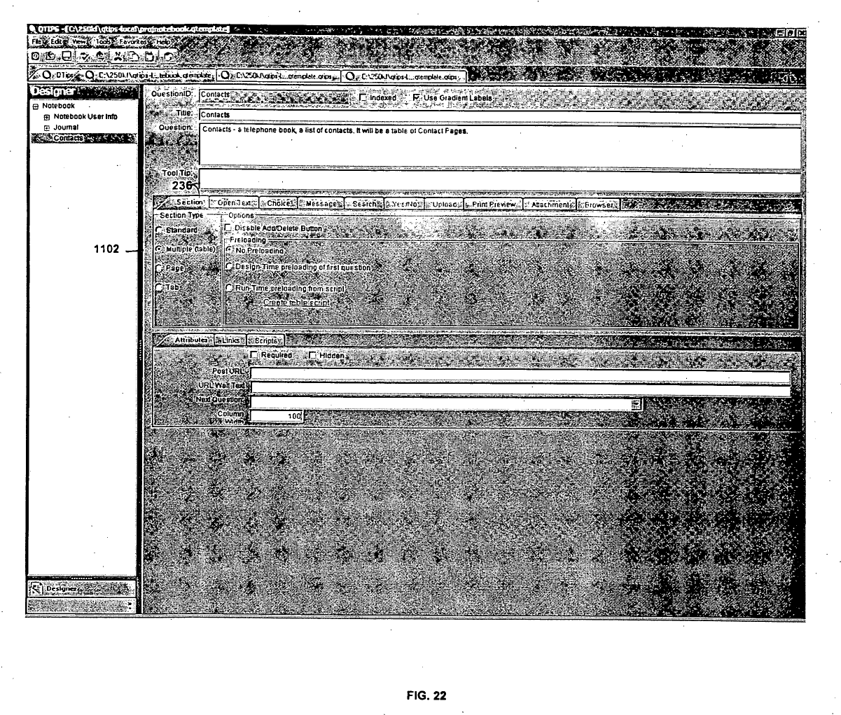

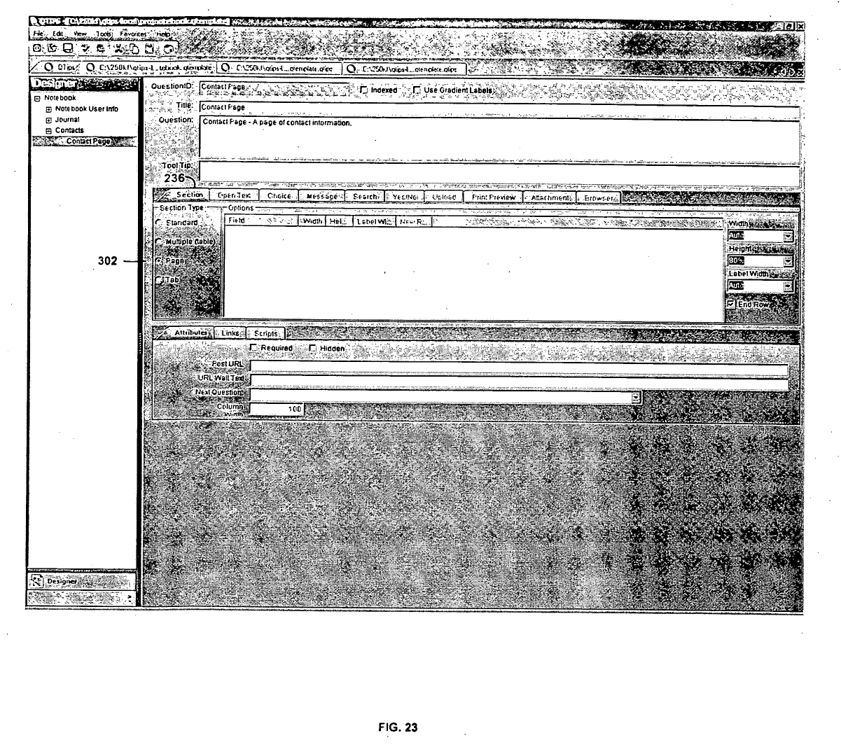

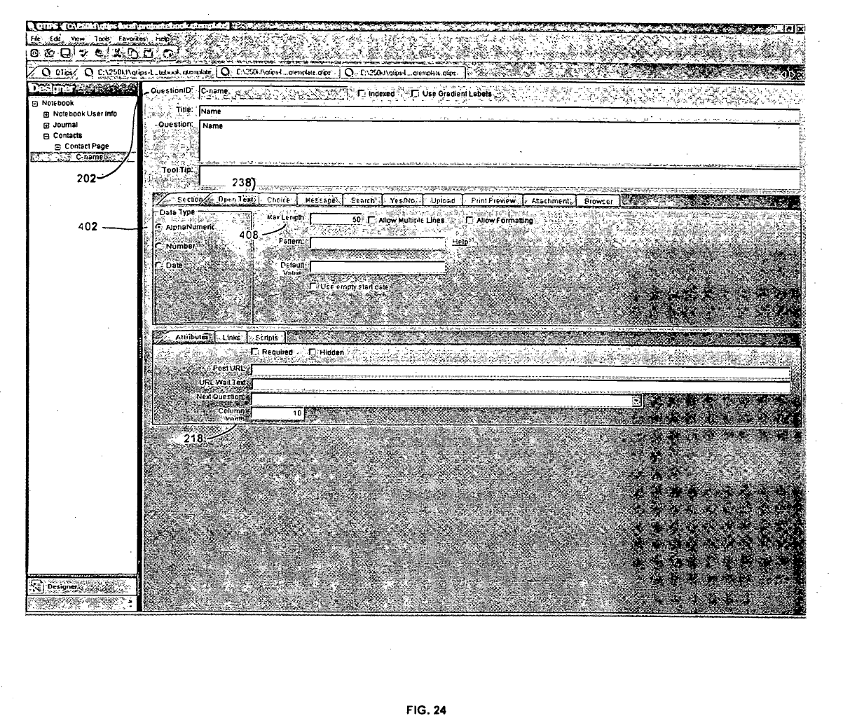

In the application, builder 102 also wants to have contacts or address book elements. In FIG. 22, builder 102 selects an option template of Section 236 with a Section Type of Multiple (table) 1102. There are several pieces of information for contacts, and in FIG. 23, builder 102 creates a Contacts Page using an option template of Section 236 with a Section Type of Page 302 for the fields. The first field is contact name, and in FIG. 24, builder 102 selects an option template of Open Text 238 with a Data Type of Alphanumeric 402. The maximum length 408 is 50 characters and the column width 218 is 10 characters. QuestionID is a unique field, and because Name was already used, this QuestionID 202 is called C-name.

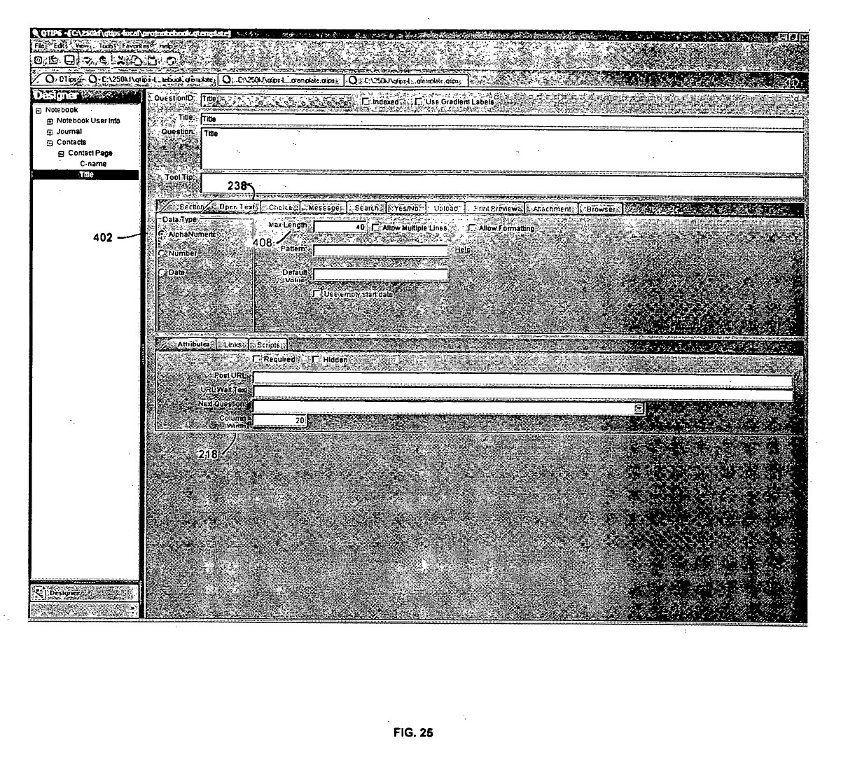

The next field is job title, and in FIG. 25, builder 102 again selects an option template of Open Text 238 with a Data Type of Alphanumeric 402. The maximum length 408 is 40 characters and the column width 218 is 20 characters.

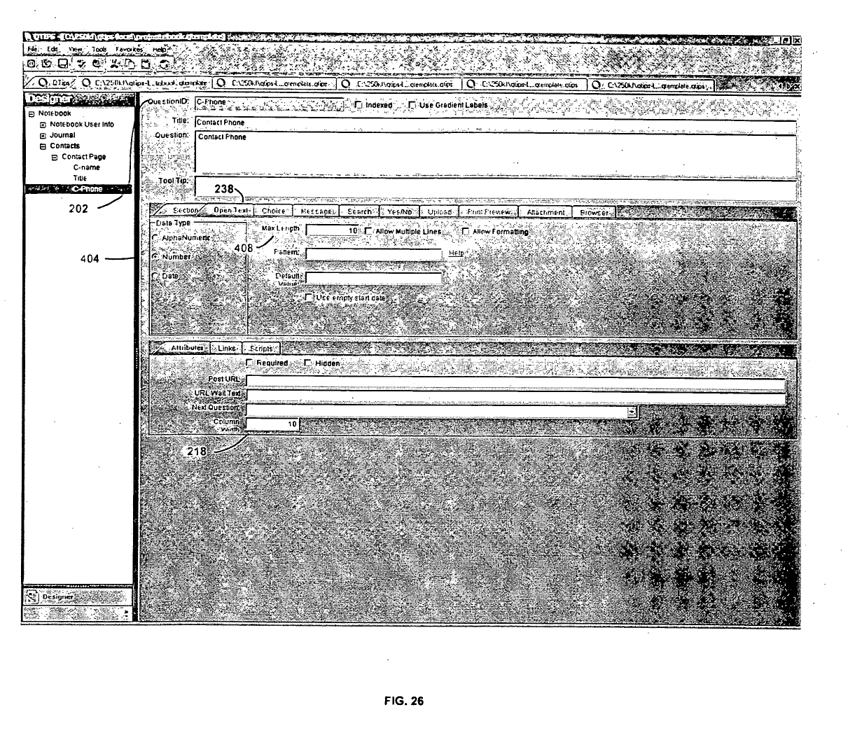

Contact telephone number is the next field, and in FIG. 26, builder 102 selects an option template of Open Text 238 with a Data Type of Number 404. The maximum length 408 is 10 characters and the column width 218 is also 10 characters. As with Name in FIG. 24, the QuestionID 202 is C-Phone because Phone was already used.

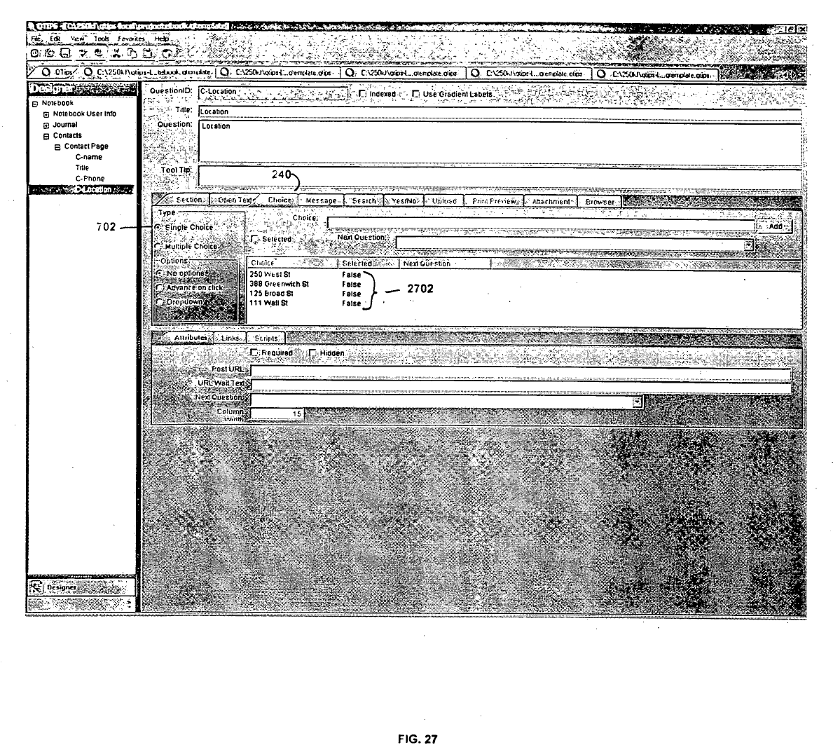

Builder 102 also wants to include location for the contacts and provides a list of single choice locations in FIG. 27. This is done by selecting an option template of Choice 240 with a Type of Single Choice 702, and listing the possible choices 2702.

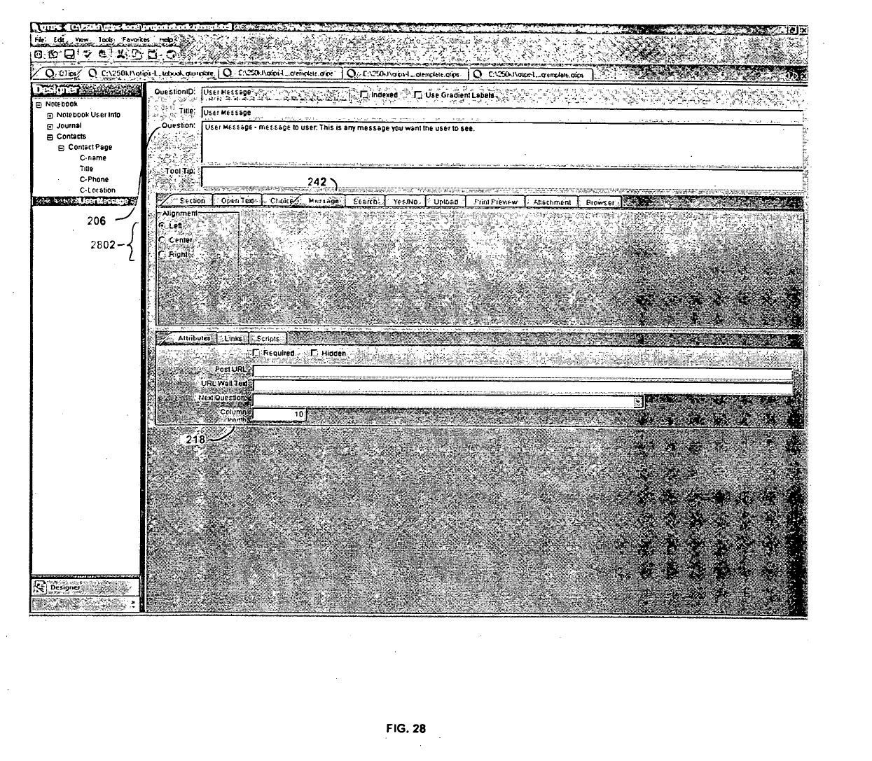

Builder 102 also wants to have a Message field. In FIG. 28, builder 102 selects an option template of Message 242. The information that is entered in Question 206 will be displayed to respondent 104 on the application screen. Left, center and right alignment 2802 of the message can be selected, and builder 102 has selected left alignment and a column width 218 of 10 characters in the example.

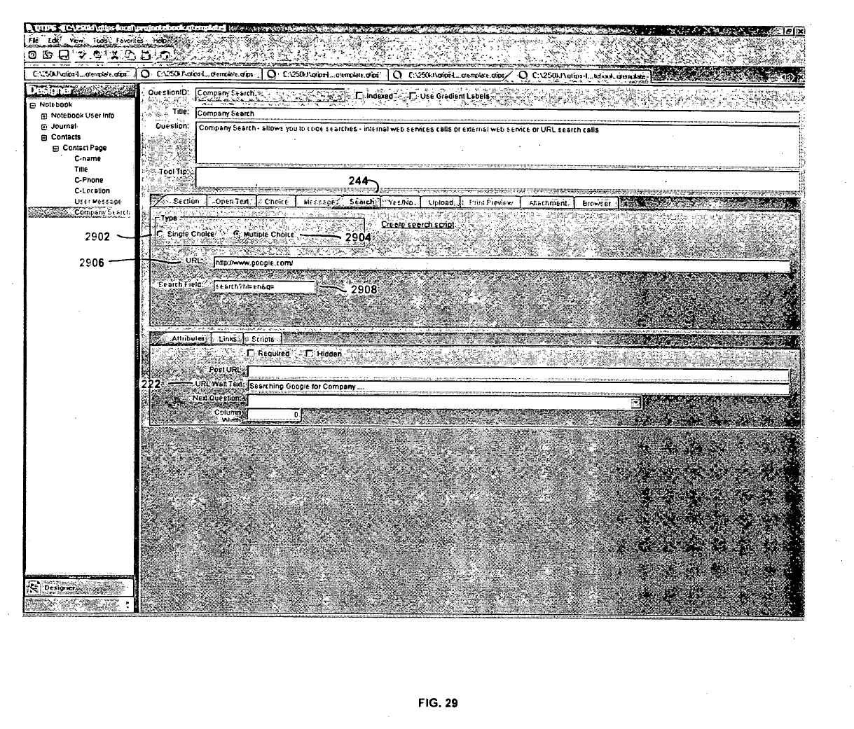

In FIG. 29, builder 102 selects an option template of Search 244. This is for a Company Search, and Single Choice 2902 and Multiple Choice 2904 there are two Types available. ULR 2906 is the search link and Search Field 2908 contains the search parameters. As illustrated, builder 102 also enters URL wait text 222.

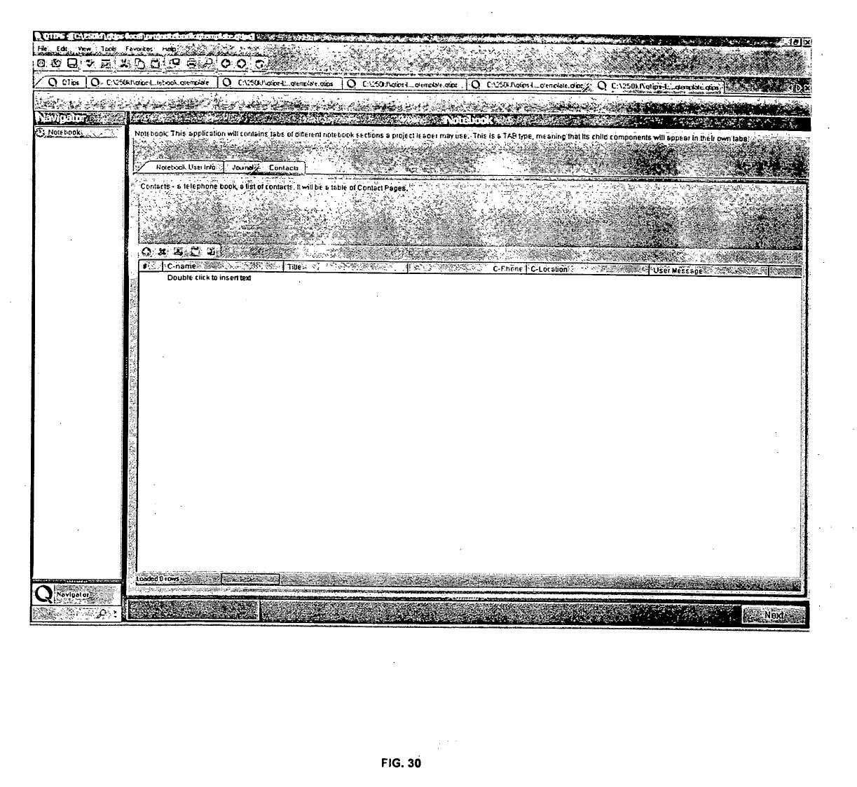

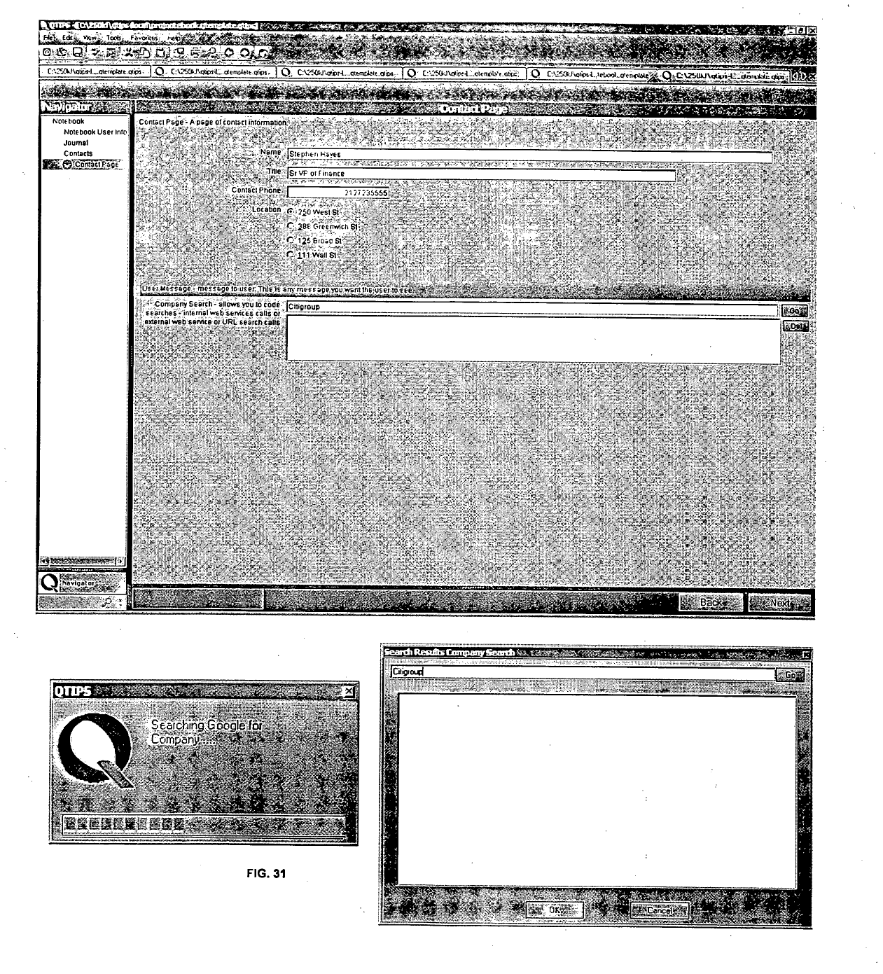

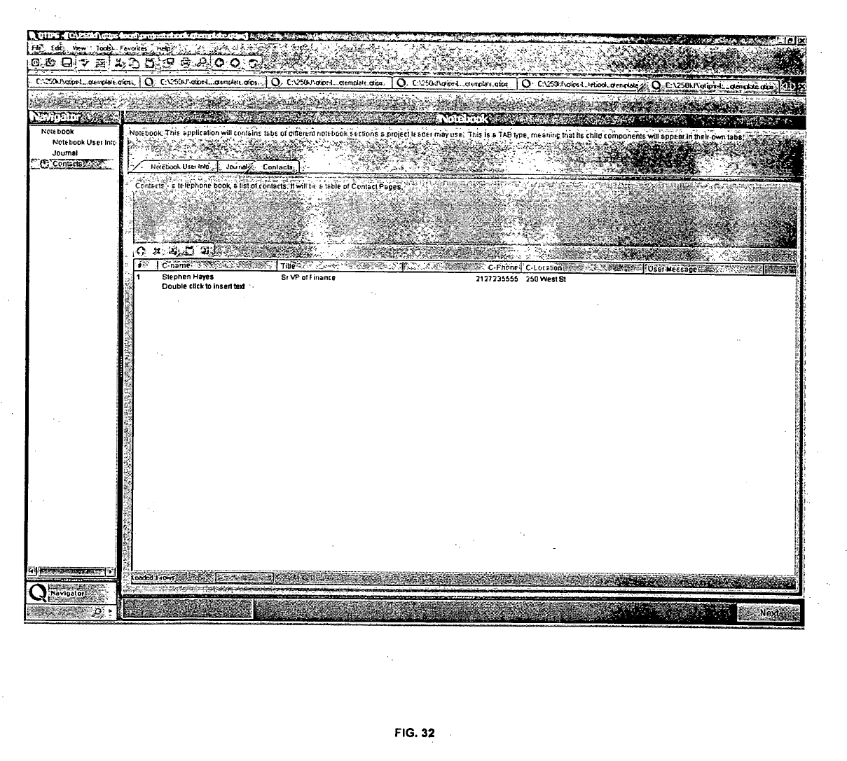

FIG. 30, provides a display of Contacts in the application as it might be seen by respondent 104, and FIG. 31 provides a display of the data entry screen for a contact, while FIG. 32 provides a display of Contacts in the application after entry of the data.

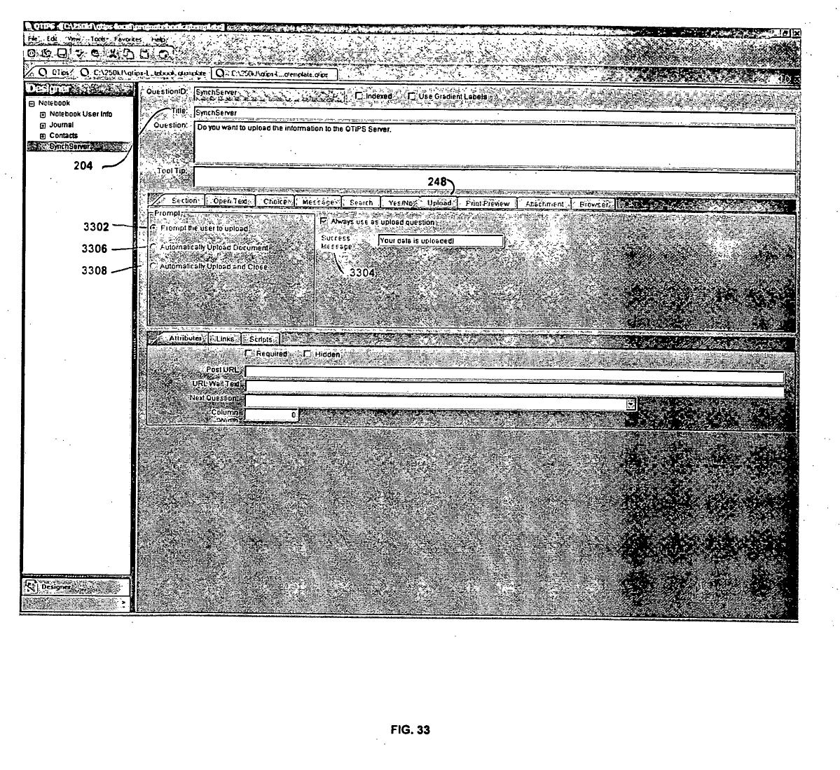

Builder 102 also wants an ability to synchronize to a server, and in FIG. 33, selects an option template of Upload 248 with a Title 204 of SynchServer. This will allow upload or saving information that was entered in the application to a server. Three prompts are provided and in the example builder 102 has selected Prompt the user to upload 3302. A success message 3304 is also available. It is also possible to have the upload performed automatically 3306 and to also automatically upload and close after the upload 3308.

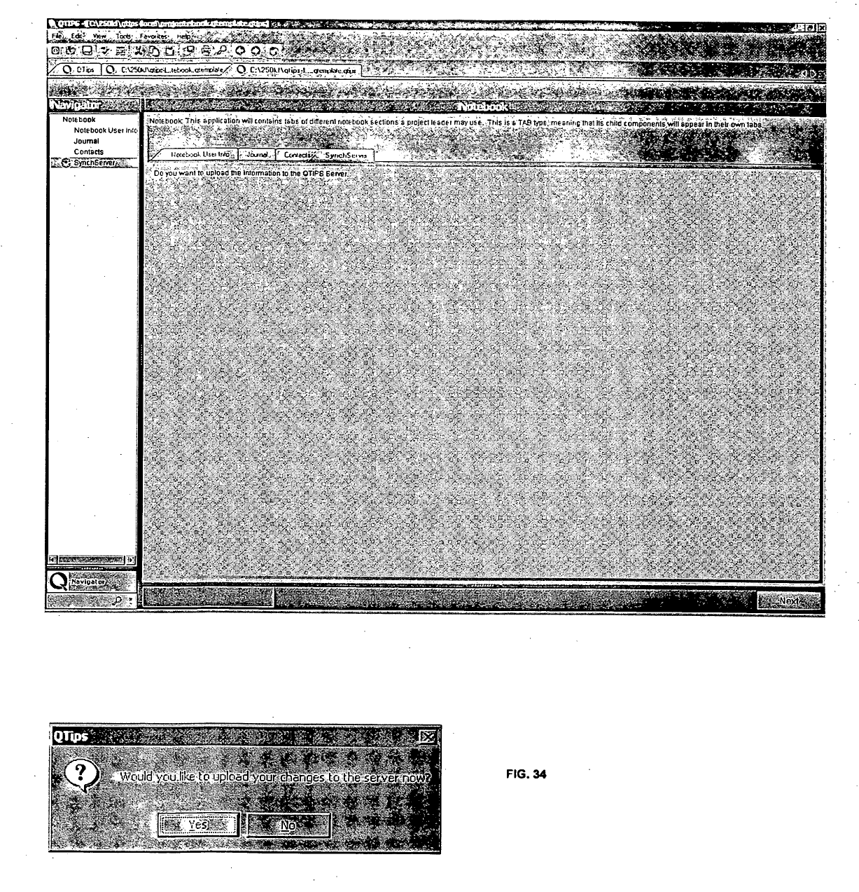

FIG. 34 provides a display of SynchServer in the application as it might be seen by respondent 104.

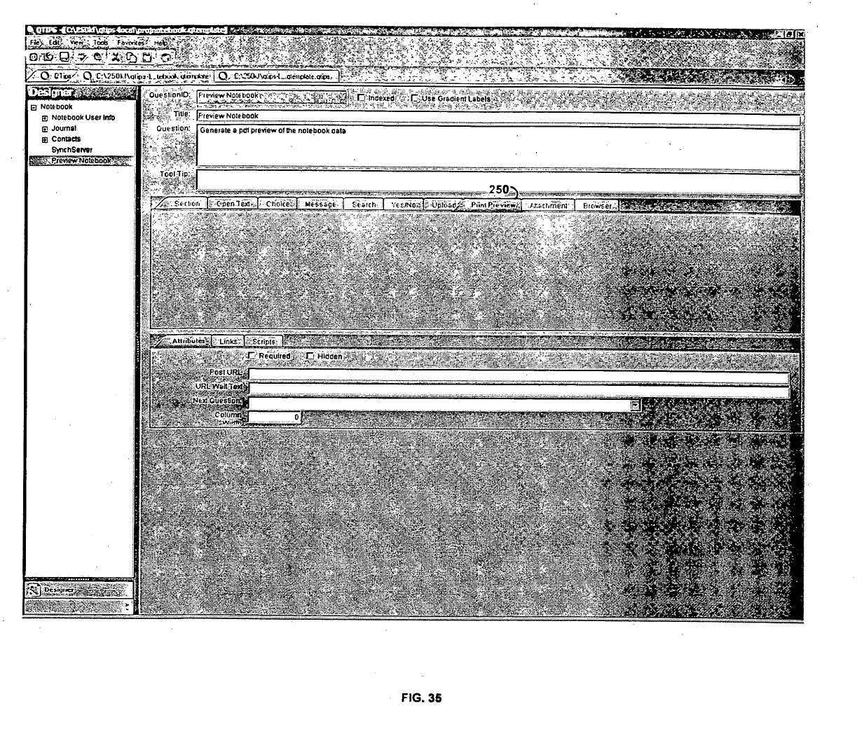

If builder 102 wants a print preview, there is an option template for that function as well. The print preview is illustrated in FIG. 35 at 250. This makes use of an XSL style sheet created for the application and applies it to the data to render in a preview document, such as a PDF document.

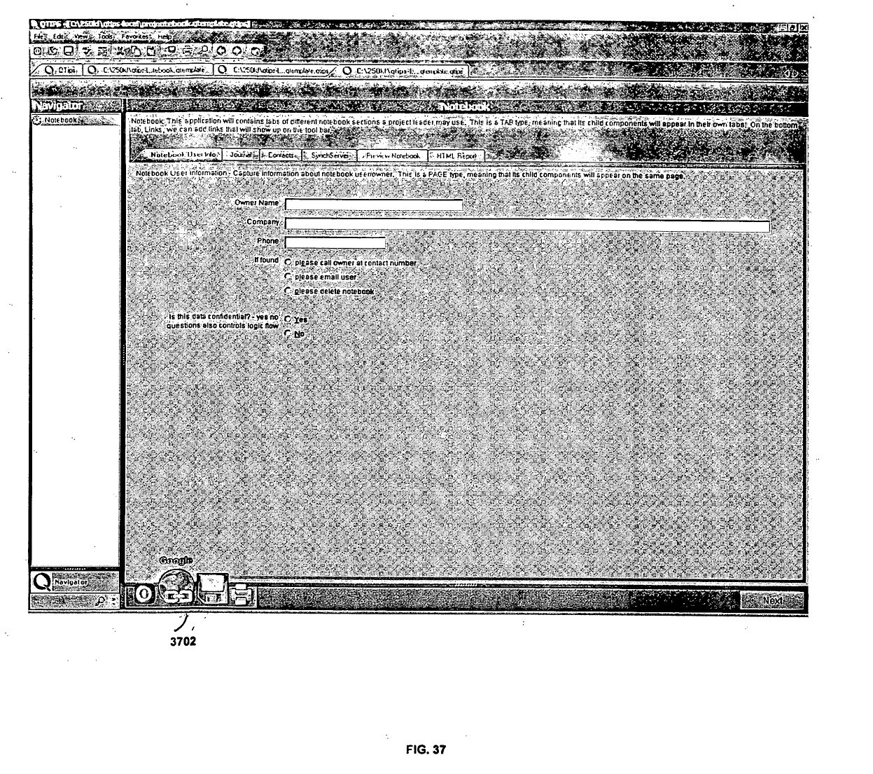

As previously mentioned, Links include: descriptions 224 and HREFs 226. In FIG. 36, Builder 102 has created links for the Notebook application that will appear as a toolbar. An example of such a toolbar 3702 is provided in FIG. 37.

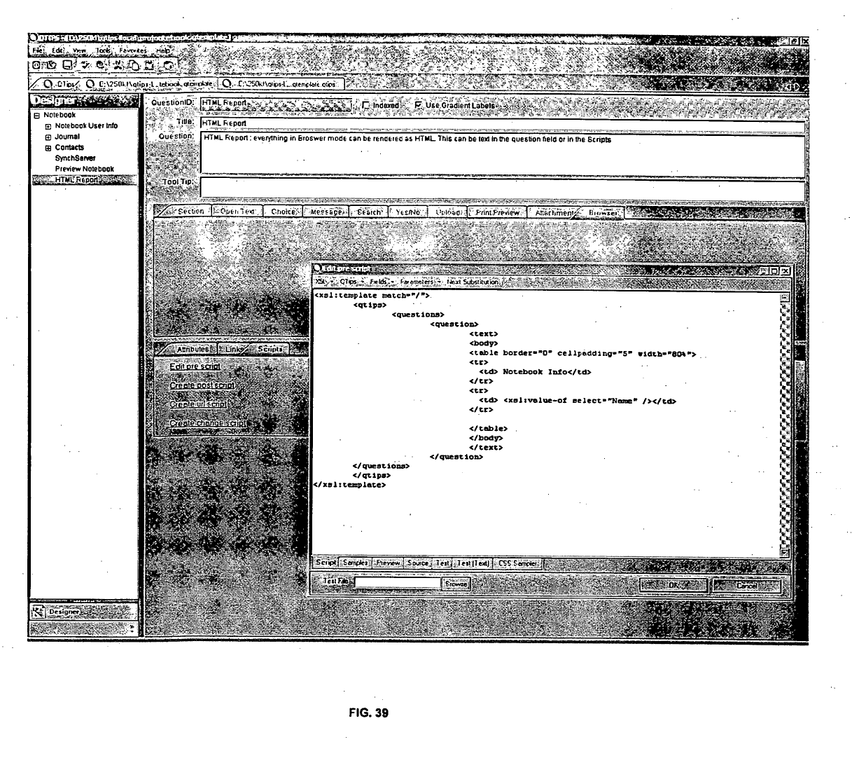

Also as previously mentioned, Scripts include: create pre script 228; create post script 230; create url script 232; and create change script 234. As illustrated in FIG. 38, if builder 1.02 selects an option template of Browser 254, they can create scripts to further control the look and feel of the application by wrapping HTML around forms, report views or data. FIG. 39 illustrates an example pre script.

As builder 102 constructs the questionnaire, system 100 creates the questionnaire in XML using the options selected from the template. Once the questionnaire is constructed, respondents 104 running the application can review the questions and provide responses.

Although illustrative embodiments have been described herein in detail, it should be noted and will be appreciated by those skilled in the art that numerous variations may be made within the scope of this invention without departing from the principle of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. A method for developing a computerized questionnaire comprising:
providing a plurality of question options in a single template;
selecting one option in the template for each of a plurality of questions; and
storing the plurality of questions and associated question options in a standard document for use in a computerized questionnaire.

2. A method according to claim 1, wherein the template further comprises a section option.

3. A method according to claim 1, wherein the template further comprises an open text option.

4. A method according to claim 1, wherein the template further comprises a single choice option.

5. A method according to claim 1, wherein the template further comprises a multiple choice option.

6. A method according to claim 1, wherein the template further comprises a yes/no option.

7. A method according to claim 1, wherein the template further comprises a message only option.

8. A method according to claim 1, wherein the template further comprises a required attribute option.

9. A method according to claim 1, wherein the template further comprises an attachment attribute option.

10. A method according to claim 1, wherein the template further comprises a column width attribute option.

11. A method according to claim 1, wherein the template further comprises a next question attribute option.

12. A method according to claim 1, wherein the template further comprises a validation URL option.

13. A method according to claim 1, wherein the template further comprises a search option.

14. A method according to claim 1, wherein the template further comprises an upload option.

15. A method according to claim 1, wherein the template further comprises a print preview option.

16. A method according to claim 1, wherein the template further comprises a browser option.

17. A method according to claim 1, wherein the section option is a logical separator.

18. A method according to claim 1, wherein the section option groups questions.

19. A method according to claim 1, wherein the open text option prompts a user to type or paste data.

20. A method according to claim 1, wherein the open text option includes a data type option.

21. A method according to claim 1, wherein the open text option includes a data length option.

22. A method according to claim 1, wherein the open text option includes a validation pattern option.

23. A method according to claim 1, wherein the single choice option includes button options.

24. A method according to claim 1, wherein the single choice option includes a list box option.

25. A method according to claim 1, wherein the multiple choice option includes button options.

26. A method according to claim 1, wherein the multiple choice option includes a list box option.

27. A method according to claim 1, wherein the standard document is an XML document.

28. A system for developing a computerized questionnaire comprising:
means for providing a plurality of question options in a single template;
means for selecting one option in the template for each of a plurality of questions; and
means for storing the plurality of questions and associated question options in a standard document for use in a computerized questionnaire.

29. A computer-readable medium having computer executable software code stored thereon, the code for developing a computerized questionnaire, the code comprising:
code to provide a plurality of question options in a single template;
code to select one option in the template for each of a plurality of questions; and
code to store the plurality of questions and associated question options in a standard document for use in a computerized questionnaire.

30. Computer executable software code transmitted as an information signal, the code for developing a computerized questionnaire, the code comprising:
code to provide a plurality of question options in a single template;
code to select one option in the template for each of a plurality of questions; and
code to store the plurality of questions and associated question options in a standard document for use in a computerized questionnaire.

31. A programmed computer for developing a computerized questionnaire, comprising:
a memory having at least one region for storing computer executable program code; and
a processor for executing the program code stored in the memory, wherein the program code comprises:
code to provide a plurality of question options in a single template;
code to select one option in the template for each of a plurality of questions; and
code to store the plurality of questions and associated question options in a standard document for use in a computerized questionnaire.

32. A method for developing a computerized questionnaire comprising:
providing a plurality of question options in a single template, wherein the options comprise a section option, an open text option, a single choice option, a multiple choice option, a yes/no option, and a message only option;
selecting one option in the template for each of a plurality of questions; and
storing the plurality of questions and associated question options in an XML document for use in a computerized questionnaire.
